(19) United States
(12) Patent Application Publication
(10) Pub. No.: US 2020/0385553 A1
(43) Pub. Date: Dec. 10, 2020

(54) COMPOSITE BUILDING MATERIALS

(71) Applicant: CMI LIMITED CO., Marietta, GA (US)

(72) Inventor: Mark GALASSO, McHenry, IL (US)

(73) Assignee: CMI LIMITED CO., Marietta, GA (US)

(21) Appl. No.: 16/940,830

(22) Filed: Jul. 28, 2020

Related U.S. Application Data
(60) Provisional application No. 62/857,028, filed on Jun. 4, 2019.

(51) Int. Cl. C08L 23/06; C08K 3/26; C08K 5/14; C08K 7/14; B29C 48/00; B29C 48/285

(52) U.S. Cl. CPC C08L 23/06; C08K 3/26; C08K 5/14; C08K 7/14; B29K 2023/065; B29C 48/2886; C08L 2207/062; C08K 2003/265; C08L 2201/08; B29C 48/0013

(57) ABSTRACT

An improved composition for use in the manufacture of building materials having improved mechanical properties, including bending strength and creep recovery. Compositions and methods are disclosed for producing a polymer composite material containing reinforcing additives/additive blend, which is useful in the manufacture of composite building materials, including decking boards, rails, posts and the like. The present composite building materials have improved flexural and impact properties over similar composite building materials known in the industry, providing a viable alternative to wood, and other composites in the building industry.

### CROSS-REFERENCE TO RELATED APPLICATION

This application claims the benefit of U.S. Provisional Patent Application Ser. No. 62/857,028 filed Jun. 4, 2019, the entirety of which is hereby incorporated herein by reference for all purposes.

### TECHNICAL FIELD

The present disclosure relates to building materials. Specifically, the present disclosure relates to an improved composition useful in the manufacture of building materials including composite dimensional lumber useful in the construction of decks, piers and associated structures, wherein the resulting products have improved mechanical features.

### BACKGROUND

Decks, whether a typically home deck, or a deck or pier used for boating, require materials that are able to withstand the environment they are built in. Decking boards and planks can be constructed from a wide variety of materials, each with its own advantages and disadvantages. Wood, including redwood, cedar and pressure-treated wood, are all popular choices for decking materials, each having its own unique characteristics. Redwood, while beautiful and durable, is dwindling in availability due to the loss of old growth forest, which is typically desired for high-quality deck material. Cedar is naturally resistant to rot and insects, but is considered a softer wood, and is prone to splintering. Pressure-treated lumber is rot and insect resistant, and is typically cheaper than redwood or cedar, and is more widely available. However, pressure treated lumber can be unstable, and shrinking, warping and twisting are all common with lesser-grade woods. Additionally, even pressure-treated lumber requires some form of maintenance through the application of paint or stain every few years to enhance and preserve the deck.

As an alternative to wood, mineral plastic composites (MPC) have found application in a multitude of commercial products in recent years. In 2018, the overall market for MPCs was estimated to be billions of pounds annually. By and large, the leading uses for MPC are found in construction markets. When compared to conventional wood or organic filled composites, MPCs have lower specific gravity, better strength/weight and are often lower cost. They also have the look of natural wood, while being much easier to maintain. However, natural wood is generally cheaper, has lower specific gravity and better strength/weight when compared to MPCs. Thus, there is a clear need to develop technologies that will improve the mechanical properties of MPCs.

Given the cost and maintenance of traditional wood or pressure-treated lumber decks, composite decking and its cousin, plastic lumber, represent the fastest-growing decking materials sold today. Composites are composed primarily of wood fibers and recycled or virgin plastic. The result is an extremely weather- and stain-resistant board that will not splinter, warp, rot or split. Plastic lumber has a primary base material of plastic (recycled and/or virgin); it contains no wood fibers. Plastic lumber is highly resistant to staining and decay, and free of knots, cracks and splinters, which plague traditional wood deck lumber. Composite decking and plastic lumber do have certain advantages over wood in that they are extremely low-maintenance and never need to be sanded, refinished or stained. Some mixed composition decking can be subject to mold and mildew in shady, damp areas of the deck, and some composites can eventually show signs of decay, due to the addition of wood or some other form of organic material in the composite. However, plastic decking does not have these issues, and can last virtually a lifetime with little to no maintenance.

Plastic lumber can be made up primarily of recycled content sourced from both post-industrial and post-consumer material. Polyethylene, including high density polyethylene (HDPE) from sources such as plastic milk jugs and shampoo bottles, provide a readily available recyclable source of material for the creation of plastic lumber. As well, polypropylene in a recycled or virgin form, is also a commonly used material for creating plastic lumber. Mineral fillers may be added to the plastic composition to increase the strength and reduce the thermal expansion of the planks. Plastic lumber is manufactured using an extrusion process.

However, even with these advantages, plastic planks having a significant length can be subject to flex or sagging. To overcome this potential issue, some manufacturers have resorted to adding a layer of fiberglass to the plastic board extrusion process, thereby creating at least one layer of fiberglass reinforcement within the interior or exterior of the board. The addition of fiberglass, however, has the disadvantage that when the decking boards are cut, the fiberglass is released into the atmosphere, where it is potentially inhaled. Therefore, it would be advantageous to provide a composition to enhance the strength and flex resistance of building materials, including deck and rail lumber.

Accordingly, it can be seen that needs exist for improved composite building materials. It is to the provision of composite building materials meeting these and other needs that the present invention is primarily directed.

### SUMMARY

The present disclosure relates to a composition for producing building materials. Specifically, the present disclosure provides compositions for producing composite building products that possess superior mechanical properties by admixing a reinforcing additive with a polymer, such as high-density polyethylene (HDPE). The reinforcing additive of this disclosure comprises generally a combination of calcium carbonate, glass fiber, and peroxide. Additionally, fillers may be added to the present composition. The resulting products produced from the present composite have been found to possess superior mechanical properties when compared to composites known in the art.

To this end, in an embodiment of the present disclosure, a polymer composition useful for the manufacture of building materials is provided. An example of a polymer composition applicable in the present disclosure includes: 50-80% wt. of a polymer, 0.5-10 wt. % of peroxide, 3-50 wt. % of glass fiber, 15-40 wt. % of calcium carbonate, and 0.04-2 wt. % of a foaming agent and other components including colorants, stabilizer anti-oxidants. An example of a polymer composite formulation useful in the present disclosure includes: (a) HDPE=67.60%; (b) peroxide=0.84%; (c) glass fiber=7.60%; (d) calcium carbonate=21.37%; (e) foaming agent=0.61%; (f) color/stabilizer/anti-oxidant package=1.98%.

It is, therefore, an advantage and objective of the present disclosure to provide a composite building material having improved mechanical properties, including improved tensile, flexural and impact characteristics. Another advantage and objective of the present disclosure is to provide a plastic composite building material providing a high strength alternative to wood-based decking products.

In one aspect, the present invention relates to a building material composition including a polymer, peroxide, glass fibers, calcium carbonate; a foaming agent and colorants and stabilizer antioxidants. In example embodiments, the composition is admixed, melted and extruded through a die head to form a solid building material component.

In example embodiments, the composition includes 50-80% wt. of the polymer, 0.5-10 wt. % of peroxide, 3-50 wt. % of glass fiber, 15-40 wt. % of calcium carbonate, and 0.04-2 wt. % of the foaming agent, colorants and stabilizer antioxidants. In one example embodiment, the polymer includes polyethylene. In another example embodiment, the polymer includes high density polyethylene. In one example embodiment, about 67.60% of the composition includes the polymer, about 0.84% of the composition includes peroxide, about 7.60% of the composition includes glass fiber, about 21.37% of the composition includes calcium carbonate, about 0.61% of the composition includes the foaming agent, and about 1.98% of the composition includes the colorants and stabilizer anti-oxidants. In example embodiments, the composition is melt-blended and extruded directly into a desired shape, the melt-blending occurring at a temperature between about 275-475 degrees Fahrenheit. In example embodiments, one or more portions of the composition are admixed in separate melt-processing steps and combined together to form the composition, which is further melt-processed together to form the building material. In example embodiments, the composition is injected in a mold, the mold being shaped substantially similar to the desired shape of the building material. In example embodiments, the composition includes a modulus of elasticity of between about 126,000-185,000 psi. In example embodiments, the composition includes a creep recovery rate of at least 75%.

In another aspect, the present invention relates to a construction board made from an extruded composite composition including a polymer, calcium carbonate, peroxide, and glass fibers. In example embodiments, the polymer is polyethylene. In another example embodiment, the polymer is a high-density polyethylene. In example embodiments, the extruded composite composition further includes a foaming agent, colorants, and/or stabilizer antioxidants. In example embodiments, the extruded composite composition includes 50-80% wt. of the polymer, 15-40 wt. % of calcium carbonate, 0.5-10 wt. % of peroxide, 3-50 wt. % of glass fibers, and 0.04-2 wt. % of the foaming agent, colorants and/or stabilizer antioxidants. In one example embodiment, 67.60% of the extruded composite composition includes the polymer, 0.84% of the extruded composite composition includes peroxide, 7.60% of the extruded composite composition includes glass fibers, 21.37% of the extruded composite composition includes calcium carbonate, 0.61% of the extruded composite composition includes the foaming agent, and 1.98% of the extruded composite composition includes the colorants and stabilizer anti-oxidants. In example embodiments, the extruded composite composition has a modulus of elasticity of between about 126,000-185,000 psi. In one example embodiment, the extruded composition has a modulus of elasticity of about 144,025 psi.

In another aspect, the invention relates to a method of forming a composite building material including providing a plurality of components to a gravimetric scale to generate a batch of a composition, the components of the batch comprising a polymer, peroxide, glass fiber, calcium carbonate, a foaming agent, and a colorants and/or stabilizer anti-oxidants; providing the batch of the composition to a blending portion of the gravimetric scale and blended for a minimum of 30 seconds; providing the blended batch of the composition into the throat of the extruder, the extruder heating, further blending, and pushing the blended batch of the composition down a barrel portion of the extruder using a rotating auger or screw, the heated and blended batch being turned into a semi-solid material and pushed out the opposite end of the extruder by the rotating screw that formed the semi-solid composite material; pushing and/or pulling the semi-solid material through a rough shaping device or die head; and pushing and/or pulling the semi-solid material into a cooling area, the cooling area comprising a form to simultaneously form the semi-solid composite material into a final desired shape as the cooling changes the semi-solid composite material into a solid material.

These and other aspects, features and advantages of the invention will be understood with reference to the drawing figures and detailed description herein and will be realized by means of the various elements and combinations particularly pointed out in the appended claims. It is to be understood that both the foregoing general description and the following brief description of the drawings and detailed description of example embodiments are explanatory of example embodiments of the invention, and are not restrictive of the invention, as claimed.

### DETAILED DESCRIPTION OF EXAMPLE EMBODIMENTS

The present invention may be understood more readily by reference to the following detailed description of example embodiments taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

The present disclosure relates to an improved composition for use in the manufacture of building materials having improved mechanical properties. Specifically, the present disclosure relates to compositions and methods for producing a polymer composite material containing reinforcing additives, which is useful in the manufacture of building materials, including decking boards, rails, posts and the like. The present composite building materials have improved flexural and impact properties over similar composite building materials known in the industry, providing a viable option to wood, and other composites in the building industry.

In example embodiments, the present composition is a combination of a polymer, a reinforcing additive blend and a filler. The reinforcing additives or additive blend, when utilized in mineral plastic composites (MPC) formulations to form composite articles, dramatically improve mechanical properties (i.e., tensile, flexural and impact) of the resulting composite articles. The reinforcing additives generally comprise a combination of a peroxide, glass fibers and calcium carbonate. According to some example embodiments, the reinforcing additives generally comprise a combination of peroxide and glass fibers. The resulting composites of the present disclosure demonstrate markedly improved physical properties (e.g., flexural modulus and impact strength) when compared to conventional MPC materials. Products constructed from the composites of this disclosure have been found to have flexural and impact properties as much as two-fold greater than composite materials that do not contain a reinforcing additive or additive blend. Composites of this disclosure have utility in many applications. Non-limiting examples include a variety of building materials. Specific applications of utility include extruded dimensional lumber products, including boards, railings and posts useful in constructing decks and piers.

In one embodiment, a polymeric matrix is melt processed with a reinforcing additive or additive blend to form a useful article. The reinforcing additive of the present disclosure includes a peroxide agent that is functionalized when mixed with calcium carbonate and glass fibers. In another embodiment, the thermoplastic matrix is melt processed with the reinforcing additives and at least one additional filler to produce a composite. The composites are produced using known, conventional melt processing techniques, wherein the end products are extruded into the desired shapes, textures and lengths.

For purposes of the present disclosure, the following terms used in this application are defined as follows:

“Filler” means an inorganic material that does not possess viscoelastic characteristics under the conditions utilized to melt process the filled polymeric matrix. Examples of fillers useful in the present disclosure include calcium carbonate and/or glass fiber.

“Composite” means a mixture of a polymer material and a filler.

The composition of the present disclosure is produced by melt processing a polymer, such as HDPE, with a reinforcing additive or additive blend which includes a peroxide agent, glass fibers and calcium carbonate together using known methods for melt extrusion. In one embodiment, the reinforcing additive or additive blend comprises 10-50% wt. of the total composition.

The polymeric matrix functions as the host polymer (HDPE) and is a primary component of the melt processable composition of the present disclosure. A wide variety of polymers conventionally recognized in the art as suitable for melt processing are useful as the polymeric matrix. They include both hydrocarbon and non-hydrocarbon polymers.

The polymeric matrix may also include blended polymers. Non-limiting examples of polymers for blending include high density polyethylene (HDPE), low density polyethylene (LDPE), and linear low-density polyethylene (LLDPE). The polymers can be sourced from recycled materials or as virgin materials.

In another aspect of the disclosure, the present composite can be melt processed with additional fillers. Typically, when a polymer matrix is melt processed with increasing loading levels of a filler, the flexural modulus of the resulting composite typically increases. By adding the reinforcing additives to a filled polymeric matrix, the flexural modulus and impact strength both increases.

The amount of the filler in the melt processable composition may vary depending upon the polymeric matrix and the desired physical properties of the finished composition. In view of the present disclosure, the selection of an appropriate amount and type of filler(s) can be made to match with a specific polymeric matrix in order to achieve desired physical properties of the finished material. Typically, the filler may be incorporated into the melt processable composition in amounts up to about 50% by weight. The filler is generally added to the melt processable composite composition at levels between about 5-50%, by weight of the formulation. Additionally, the filler may be provided in various forms depending on the specific polymeric matrices and end use applications. Non-limiting examples of fillers include calcium carbonate and/or glass filler. These fillers can be provided and used in form include powder and pellet form.

The melt processable composition of the present disclosure can be prepared using a variety of known manufacturing processes. For example, the thermoplastic matrix, reinforcing additive/additive blend and the filler can be combined by any of the blending means usually employed in the plastics industry, such as with a compounding mill, a gravimetric mixer, or another form of suitable mixing apparatus. The polymeric matrix, filler and the reinforcing additive may be provided in any convenient form, for example, a powder, pellet, or granular product. The mixing operation is most conveniently carried out at a temperature above the melting point or softening point of the polymeric matrix, typically in a range of 275-475 degrees Fahrenheit (F).

The resulting melt-blended mixture can be either extruded directly into the form of the final product shape or pelletized or otherwise comminuted into a desired particulate size or size distribution and fed to an extruder, which typically will be a single-screw extruder that melt-processes the blended mixture to form the final product shape. In this manner, the composition of the present disclosure can be used in the manufacture of a variety of building materials.

In another embodiment, the reinforcing additive/additive blend is premade in a separate melt processing step using a twin-screw extruder. The premade additive is subsequently melt processed with a polymeric matrix and filler. The resulting composite exhibits superior performance results when the reinforcing additive is premade using this protocol.

Melt-processing typically is performed at a temperature from 275 to 475° F., although optimum operating temperatures are selected depending upon the melting point, melt viscosity, and thermal stability of the composition. Different types of melt processing equipment, such as extruders, may be used to process the melt processable compositions of this disclosure.

According to alternate example embodiments, various other forms of manufacturing such as injection molding can be utilized to produce the composite building materials as described herein.

The composites of the present disclosure are suitable for manufacturing articles in the construction industry. For example, in the construction industry articles incorporating the composition of the present invention may include decking, sheeting, structural elements, roofing tiles, and siding. The improved mechanical properties of resulting materials enable thin and or hollow profiles, thereby reducing cost and weight for end use applications. Those of skill in the art of designing construction articles can select specific profiles for desired end use applications.

The following example as described herein illustrates a formulation useful in the present disclosure and the steps in the process for producing the plastic building materials of the present disclosure. According to example embodiments, the 6 individual components that will make up the composition are added to the holding section of a gravimetric scale. According to one example embodiment, the gravimetric scale is programmed by an operator to generate a batch using the following recipe: HDPE=67.60%; peroxide=0.84%; glass fiber=7.60%; calcium carbonate=21.37%; foaming agent=0.61%; and color/stabilizer/antioxidant package=1.98%. The gravimetric scale generates the batch, by weight, as directed by the recipe. The batch is dropped into a blending portion of the gravimetric scale and blended for a minimum of 30 seconds. According to one example embodiment, the blended batch is gravity fed into the throat of the extruder. The extruder heats, further blends and pushes the recipe down the barrel portion of the extruder using a rotating auger, commonly referred to as the “screw”. According to one example embodiment, the heated and blended batch is turned into a semi-solid material and pushed out the opposite end of the extruder by the rotating screw creating the semi-solid composite material. According to example embodiments, the semi-solid composite material is pushed and/or pulled through a rough shaping device, commonly referred to as a “die head”. According to one example embodiment, the semi-solid composite material is pushed and/or pulled into a cooling area that typical contains a form to simultaneously form the semi-solid composite material into the final desired shape as the cooling changes the semi-solid composite into a solid material.

The resulting articles of the present invention produced by melt processing exhibit superior mechanical characteristics in the field of composite structures. For example, a composite comprised of a reinforcing additive according to the present invention exhibits substantial increases in the composite's flexural modulus, flexural strength, and impact strength.

According to one example embodiment, a bending strength and creep recovery test were conducted according to the protocol and techniques of ASTM D7032. Deck boards constructed from the preferred formulation or a slight variation thereof, having lengths of 28 inches (5.6 inches in width, about 1 inch in depth, and between about 4-5 lbs in weight) were tested for both bending strength and creep recovery. In example embodiments, the preferred polymer composite formulation comprises 50-80% wt. of a polymer, 0.5-10 wt. % of a peroxide, 3-50 wt. % of a glass fiber, 15-40 wt. % of a calcium carbonate, and 0.04-2 wt. % of a foaming agent and other components/materials including colorants and/or stabilizer anti-oxidants. For example, according to one preferred example embodiment, the polymer composite formulation comprises 67.60% HDPE, 0.84% peroxide, 7.60% glass fiber, 21.37% calcium carbonate, 0.61% foaming agent, and 1.98% color/stabilizer/antioxidant package. According to the bending strength tests conducted, the preferred polymer composite formulation resulted in a modulus of elasticity of between about 126,000-185,000 psi, for example about 144,025 psi according to one preferred example embodiment. Indeed, the modulus of elasticity of the preferred polymer composite formulation is about 50-65% better than that of conventional MPCs such as Lumberock® Premium Decking products, for example, which have been tested to have a modulus of elasticity of about 88,182 psi.

“Creep recovery” is the rate of decrease in deformation that occurs when load is removed after prolonged application in a creep recovery test. According to the creep recovery test, deck boards constructed from the preferred formulation or a slight variation thereof, having lengths of 28 inches (5.6 inches in width, about 1 inch in depth, and between about 4-5 lbs in weight) underwent a 24 hour loading period, for example, and the deflections and recovered deflection were measured to determine the creep recovery rate. According to example embodiments of the present invention, the creep recovery rate was calculated to be at least 75%. According to one example embodiment, the applied load was 105.04 lbs, the deflection of the board after initially applying the load was 0.250 inches, the deflection of the board after the load remained applied for 24 hours was 0.760 inches, the deflection of the board after the load was removed was 0.530 inches, and the deflection of the board after the load had been removed for 24 hours (e.g., 24 hour recovery) was 0.131 inches. Thus, the total deflection was 0.760 inches, the recovered deflection was 0.629 inches, and thus, the creep recovery rate was calculated to be about 83%.

Thus, according to example embodiments, the composite building materials (and formulations thereof) as described herein preferably comprise substantially improved mechanical properties compared to known MPCs such as Lumberock® Premium Decking products. According to example embodiments, the reinforcing additives such as peroxide and/or glass fiber have been found to contribute to the substantial improvements of the composite building material's mechanical properties.

According to example embodiments, the composite building materials of the present invention can comprise various cross-sectional profiles comprising desired dimensions. For example, according to example embodiments, the composite building materials can comprise generally rectangular cross-sectional profiles such as nominal 5/4 inch×6 inch (actual size being 1.0 inch×5.5 inches (2.5 cm×14 cm)) in lengths of 6 feet, 8 feet, 12 feet and 16 feet; nominal 2 inches×6 inches (actual size being 1.5 inches×5.5 inches (3.8 cm×13.7 cm)) in lengths of 6 feet, 8 feet, 12 feet and 16 feet; nominal 2 inches×8 inches (actual size being 1.5 inches×7.375 inches (3.8 cm×18.732 cm)) in lengths of 6 feet, 8 feet, 12 feet and 16 feet; and/or nominal 2 inches×4 inches (actual size being 1.5 inches×3.5 inches (3.8 cm×8.89 cm)) in lengths of 6 feet, 8 feet, 12 feet and 16 feet. Preferably, according to other example embodiments, the composite building materials as described herein can comprise rectangular cross-sectional profiles of various other desired dimensions. In alternate example embodiments, the composite building materials as described herein can comprise various other cross-sectional profiles of desired dimensions including generally square, circular, oval, polygonal and/or others as desired.

According to another example embodiment, the present invention relates to a method of forming a composite building material comprising providing a plurality of components to a gravimetric scale to generate a batch of a composition, the components of the batch comprising a polymer, peroxide, glass fiber, calcium carbonate, a foaming agent, and a colorants and/or stabilizer anti-oxidants; providing the batch of the composition to a blending portion of the gravimetric scale and blended for a minimum of 30 seconds; providing the blended batch of the composition into the throat of the extruder, the extruder heating, further blending, and pushing the blended batch of the composition down a barrel portion of the extruder using a rotating auger or screw, the heated and blended batch being turned into a semi-solid material and pushed out the opposite end of the extruder by the rotating screw that formed the semi-solid composite material; pushing and/or pulling the semi-solid material through a rough shaping device or die head; and pushing and/or pulling the semi-solid material into a cooling area, the cooling area comprising a form to simultaneously form the semi-solid composite material into a final desired shape as the cooling changes the semi-solid composite material into a solid material. According to alternate example embodiments, one or more steps of the method as described herein may be altered and/or eliminated. According to other example embodiments, one or more additional steps can be added as desired.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein

While the invention has been described with reference to example embodiments, it will be understood by those skilled in the art that a variety of modifications, additions and deletions are within the scope of the invention, as defined by the following claims.

What is claimed is:

1. A building material composition comprising:
a polymer;
peroxide;
glass fiber;
calcium carbonate;
a foaming agent; and
colorants and stabilizer antioxidants, wherein said composition is admixed, melted and extruded through a die head to form a solid building material component.

2. The building material of claim 1, wherein the composition comprises 50-80% wt. of the polymer, 0.5-10 wt. % of peroxide, 3-50 wt. % of glass fiber, 15-40 wt. % of calcium carbonate, and 0.04-2 wt. % of the foaming agent, colorants and stabilizer antioxidants.

3. The building material of claim 1, wherein the polymer comprises polyethylene.

4. The building material of claim 1, wherein the polymer comprises high density polyethylene.

5. The building material of claim 1, wherein about 67.60% of the composition comprises the polymer, about 0.84% of the composition comprises peroxide, about 7.60% of the composition comprises glass fiber, about 21.37% of the composition comprises calcium carbonate, about 0.61% of the composition comprises the foaming agent, and about 1.98% of the composition comprises the colorants and stabilizer anti-oxidants.

6. The building material of claim 1, wherein the composition is melt-blended and extruded directly into a desired shape, the melt-blending occurring at a temperature between about 275-475 degrees Fahrenheit.

7. The building material of claim 1, wherein one or more portions of the composition are admixed in separate melt-processing steps and combined together to form the composition, which is further melt-processed together to form the building material.

8. The building material of claim 1, wherein the composition is injected in a mold, the mold being shaped substantially similar to the desired shape of the building material.

9. The building material of claim 1, wherein the composition comprises a modulus of elasticity of between about 126,000-185,000 psi.

10. The building material of claim 1, wherein the composition comprises a creep recovery rate of at least 75%.

11. A construction board made from an extruded composition, the extruded composition comprising:
a polymer;
calcium carbonate;
peroxide; and
glass fibers.

12. The construction board of claim 11, wherein the polymer comprises polyethylene.

13. The construction board of claim 12, wherein the polymer comprises high density polyethylene.

14. The construction board of claim 11, wherein the extruded composition further comprises a foaming agent, colorants, and/or stabilizer antioxidants.

15. The construction board of claim 14, wherein the extruded composition comprises 50-80% wt. of the polymer, 15-40 wt. % of calcium carbonate, 0.5-10 wt. % of peroxide, 3-50 wt. % of glass fibers, and 0.04-2 wt. % of the foaming agent, colorants and/or stabilizer anti-oxidants.

16. The construction material of claim 15, wherein 67.60% of the extruded composition comprises the polymer, 0.84% of the extruded composition comprises peroxide, 7.60% of the extruded composition comprises glass fibers, 21.37% of the extruded composition comprises calcium carbonate, 0.61% of the extruded composition comprises the foaming agent, and 1.98% of the extruded composition comprises the colorants and stabilizer anti-oxidants.

17. The construction material of claim 14, wherein the extruded composition comprises a modulus of elasticity of between about 126,000-185,000 psi.

18. The construction material of claim 17, wherein the extruded composition comprises a modulus of elasticity of about 144,025 psi.

19. A method of forming a composite building material comprising:
providing a plurality of components to a gravimetric scale to generate a batch of a composition, the components of the batch comprising a polymer, peroxide, glass fiber, calcium carbonate, a foaming agent, and a colorants and/or stabilizer antioxidants;
providing the batch of the composition to a blending portion of the gravimetric scale and blended for a minimum of 30 seconds;
providing the blended batch of the composition into the throat of the extruder, the extruder heating, further blending, and pushing the blended batch of the composition down a barrel portion of the extruder using a rotating auger or screw, the heated and blended batch being turned into a semi-solid material and pushed out the opposite end of the extruder by the rotating screw that formed the semi-solid composite material;
pushing and/or pulling the semi-solid material through a rough shaping device or die head; and
pushing and/or pulling the semi-solid material into a cooling area, the cooling area comprising a form to simultaneously form the semi-solid composite material into a final desired shape as the cooling changes the semi-solid composite material into a solid material.
